(19) United States
(12) Patent Application Publication
(10) Pub. No.: US 2011/0204677 A1
(43) Pub. Date: Aug. 25, 2011

(54) DAM SKIRT AERODYNAMIC FAIRING DEVICE

(76) Inventors: Richard M. Wood, Virginia Beach, VA (US); Drew Landman, Norfolk, VA (US)

(21) Appl. No.: 12/861,610

(22) Filed: Aug. 23, 2010

Related U.S. Application Data
(60) Provisional application No. 61/274,840, filed on Aug. 21, 2009.

(51) Int. Cl. B62D 35/00

(52) U.S. Cl. 296/180.1

(57) ABSTRACT

A method and device for the reduction of aerodynamic drag and for improved performance and stability of ground vehicles by reducing the mass and velocity of the flow passing under a vehicle is described. The device is particularly suited for a single unit truck system but may also be applied to a tractor-trailer truck system or any combination vehicle that includes a motorized lead vehicle pulling one or more non-motorized vehicles. The device is designed to control the flow from entering the undercarriage region from the front and side of the subject ground vehicle system.

### CROSS-REFERENCE TO RELATED APPLICATION

This application claims the benefit of U.S. Provisional Application No. 61/274,840, filed Aug. 21, 2009, which is hereby incorporated by reference in its entirety.

### ORIGIN OF THE INVENTION

The invention described herein was made by employees of the United States Government, and may be manufactured and used by or for the Government without payment of any royalties thereon or therefore.

### FIELD OF INVENTION

The invention relates to the reduction of aerodynamic drag for moving ground vehicles; specifically to an improved method and device for the reduction of aerodynamic drag and for improved performance and stability of ground vehicles by reducing the mass and velocity of the flow passing under a vehicle.

### BACKGROUND OF THE INVENTION

The flow passing under a ground vehicle imparts a drag force to the vehicle when it impinges on and flows around the vehicle undercarriage components, landing gear, axles, brake components, mud flap systems, wheel wells and fenders, wheels, tires and various other vehicle components attached to or a part of the underside of a vehicle. Ground vehicles may be either a single non-articulating type or a multi component vehicle that articulates. An articulating ground vehicle typically consists of a motorized lead vehicle pulling one or more non-motorized vehicles. It would be desirable to control the flow from entering the undercarriage region from the front and side of a ground vehicle or ground vehicle component.

There have been several attempts to reduce the aerodynamic drag associated with the undercarriage and wheel systems of ground vehicles. Undercarriage and wheel system drag may comprise 25 percent of the vehicle's total drag.

The undercarriage is comprised of all components located on the underside of the vehicle and includes the vehicle wheels, axles, brake system, frame structure, etc. The flow passing around a ground vehicle enters the undercarriage region from the side and front of the vehicle or vehicle component. The undercarriage flow is characterized as unsteady and dynamic and comprised of various size and strength eddy currents. The unsteady nature of the undercarriage flow is a result of the flow interacting with the ground or road, rotating wheels, brake systems, axles, and the various components comprising the vehicle or vehicle component lower surface.

Relative to the free stream static pressure, the undercarriage flow imparts an increased pressure on surfaces that face forward and a decreased pressure on surfaces that face aft. The increase in pressure acting on the forward-facing surfaces and the decreased pressure acting on the aft-facing surfaces both generate an aerodynamic drag force. It is estimated that the pressures acting on the wheel assembly accounts for one-half of the undercarriage drag, with the remaining drag being attributed to the flow interacting with numerous small structures comprising the remaining undercarriage systems. Previous attempts have addressed the undercarriage drag by installing either spanwise or streamwise aerodynamic fairings to the underside to either divert undercarriage flow from the wheel assembly or to block flow from entering the undercarriage region from the side. The flow diverter devices are spanwise fairings that mount to the undercarriage immediately forward of the wheel assembly. The flow diverter fairings are angled downward or outward to divert the undercarriage flow from the wheel assembly. The flow blocking devices are streamwise fairings that mount beneath the vehicle outside edge forward of the aft most wheel assembly and the forward most wheel system. Both types of fairings show increased benefit with increased vertical extent of the fairing.

Conventional approaches have used the flow diverter undercarriage fairings to reduce the mass of undercarriage flow that impinges onto the wheel assembly. Conventional fairing devices, while successful in reducing the mass of flow impinging on the wheel assembly and thereby reducing the wheel assembly drag, do not significantly affect the undercarriage drag. The limited effectiveness of these devices is a result of the drag generated by the device itself, sometimes referred to as device drag. The device drag for these fairings may be equal to the wheel assembly drag. These devices only reduce the wheel assembly drag and do not reduce the remaining undercarriage drag associated with the various components.

Other approaches have used the undercarriage side fairings to reduce the mass and velocity of the flow entering the undercarriage region. Conventional undercarriage side fairings or side flow blocking devices, while successful in reducing the mass of flow entering the undercarriage region, they are limited to side flow. Such devices may be simple rigid structures or complex active, flexible and variable geometry-systems. The simple devices are designed to have a limited vertical and longitudinal extent in order to reduce the impact on operations and maintenance. Limiting the vertical and longitudinal extent of the device also significantly reduces the side flow blocking capability and results in a minimal aerodynamic drag reduction benefit. The complex devices typically have features that are active, flexible, and/or variable in order to maximize the flow blocking capability while minimizing the impact on operations. The complex devices typically consist of multiple components. The complexity of these devices results in increased weight, maintenance, and cost. Each of the undercarriage side flow blocking devices consists of a vertically extended structure that attaches to the lower surface outer side edges of a vehicle or vehicle component, and are generally a partial approach to reducing undercarriage flow.

### SUMMARY OF THE INVENTION

The invention relates to an aerodynamic fairing device for reducing the aerodynamic drag on a ground vehicle. Embodiments of the device may include, a first panel system attached to the left underside of the vehicle and extending downward from the vehicle, including a forward portion of the panel system that has substantial forward projected area and an aft portion of the panel system that has negligible forward projected area and is located aft of the forward portion of the panel system; and a second panel system attached to the tight underside of the vehicle and extending downward from the vehicle, including a forward portion of the panel system that has substantial forward projected area and a aft portion of the panel system that has negligible forward projected area and is located aft of the forward portion of the panel system. The panel systems on the left and right side of the vehicle may be comprised of; a single integral panel with a forward portion and an aft portion where the forward portion has substantial forward projected area and the aft portion has negligible forward projected area, or the panel system may be comprised of multiple longitudinal segments comprising the forward and aft portions. Each panel system typically extends downward from the vehicle a distance less than 99% of the distance from the bottom surface of the vehicle to the surface that the vehicle is moving over. Each first and second panel system may extend downward, a substantially equal distance from the bottom surfaces of the vehicle, the shape and distance of the downward extension may vary along the length of each first and second panel system.

In one embodiment, the individual panels of the left or right side panel system are integrally connected to each other. In another embodiment the panels may also be an integral extension of the side surface of the vehicle. The panels may have various profiles, such as swept leading or trailing edges. In another embodiment, the panels are connected to the vehicle such that the panels may be folded so as to be substantially adjacent and proximate the bottom surface of the vehicle when not in use. In another embodiment, the panels are connected to the vehicle such that the panels may be folded so as to be substantially adjacent and proximate the side surface of the vehicle when not in use. In still another embodiment, the panels are connected to the vehicle such that the panels may be slid forward or aft so as to be substantially adjacent to each other when not in use. The panels may also be slidably connected to the vehicle such that the panels slide longitudinally along the vehicle. The distance between at least one of the first or second pairs of panels may be adjustable.

One aspect of the invention is to prohibit flow from entering the undercarriage region and interacting with the complex geometry comprising the undercarriage and wheel assembly by creating two similar structures that attach to the underside or the sides of the vehicle. The two similar panel systems may be light-weight aerodynamic fairings that attach to the underside of a ground vehicle as a single unit, un-articulated, ground vehicle or a component of an articulated ground vehicle such as a trailer. The left and right side panel systems may attach to the underside of the vehicle near the outside edges of the vehicle or vehicle component. The left and right side panel systems may be two similar structures that mount to the right and left underside or side of a vehicle and are of minimum vertical extent where each left and each right side panel system include a forward portion and a rear portion that attach to the vehicle. The aft portion of each structure may be positioned parallel to and below the underside of the vehicle and the forward portion of each structure has an aft section that is in close proximity to the forward section of the aft portion and the forward section of the forward portion extends inward under the vehicle. Each structure extends vertically downward as close as practical to the ground based upon operational and maintenance criteria. Each structure is located longitudinally between the aft end of the vehicle or vehicle component and the vehicle forward wheel assembly. Each structure is variable in length and is capable of covering a variable longitudinal distance between the vehicle aft end and the vehicle forward wheel assembly.

The flow blocking performance of each of the first and second panels is enhanced through the effective use of ground effect interference. Each of the first and second panels accomplishes the flow control and drag reduction goals with a vertically orientated surface that has an aft portion that has negligible forward projection area and a forward portion that has significant forward projection area. The forward and aft portions of each structure may be of similar or varying longitudinal and vertical length.

Embodiments of the left side and right side structure may have a forward portion and an aft portion. The aft portion and the forward portion of each left side and each right side structure may be divided into multiple segments to address installation, maintenance, and operational concerns. A segment is comprised of a single panel and a form of rigid attachment of the panel to the vehicle or adjacent panels. The forward portion of each structure is shaped to meet the operational, maintenance, and performance needs of the user. The aft portion of each structure is orientated in such a manner as to minimize the forward projected area. If the aft and forward portions of each left and right side structure are separate panels or panel systems then the aft most edge of the forward portion will be shaped and positioned to approximately match the shape and position of the forward most edge of the aft portion. The left and right structures may allow longitudinal adjustment of the aft portion by means of a slide engagement between panel segments comprising the aft portion of the structure.

The forward portion of each structure is designed to control flow from entering the undercarriage region by redirecting the flow over aerodynamically shaped surfaces and away froth the undercarriage region. The forward portion may also be designed to redirect residual flow inboard over aerodynamically contoured surfaces that will control the flow to minimize drag. The longitudinal position of the forward portion is critical to maximizing the flow control benefit while minimizing the aerodynamic drag force acting on the forward portion. Locating the forward portion as far forward as possible places the forward portion of the structure in a flow, of lower dynamic pressure that minimizes the drag force on the forward portion. The aft portion of each structure is designed to block flow from entering the undercarriage region from the side of the vehicle. The flow control strategy allows the invention to block a significantly greater mass of flow from entering the undercarriage region-compared to a typical single panel fairing.

### BRIEF DESCRIPTION OF THE DRAWINGS

The invention will be better understood in relation to the attached drawings illustrating preferred embodiments, wherein:

FIG. 1A is a front oblique view of a single unit non-articulated truck.

FIG. 1B is a side view of a single unit non-articulated truck.

FIG. 2A is a front oblique view of a single unit non-articulated truck with an embodiment of the device installed.

FIG. 2B is aside view of a single unit non-articulated truck with an embodiment of the device installed.

FIG. 3A is a front oblique view of a single, unit non-articulated truck showing the front portion and aft portion of an embodiment of the device installed.

FIG. 3B is a lower surface view of a single unit non-articulated truck showing the front portion and aft portion of an embodiment of the device installed.

FIG. 4A is across section view of the flow features under a single unit truck.

FIG. 4B is a cross section view of the flow features under a single unit truck with an embodiment of the device installed.

FIG. 5A-5C are detailed views of representative panel structures of an, embodiment of the device.

FIG. 6A-6C are detailed views of representative panel support structure of an embodiment of the device.

FIG. 7A-7J are detailed views of representative panel cross section shapes of an embodiment of the device.

FIG. 8A is a side view of a single unit truck of an embodiment of the device installed with a modified lower edge extension.

FIG. 8B are detailed views of representative panel lower edge concepts of an embodiment of the device.

FIG. 9A-9C is a side view of a single unit truck with an embodiment of the device installed with variations in the vertical drop distance.

FIGS. 10A-10E are side views of a single unit truck with an embodiment of the device installed showing representative panel concepts.

FIGS. 11A-11F are lower surface views of a single unit truck with an embodiment of the device installed showing representative forward portion shapes and inward extension lengths.

FIGS. 12A-12C are lower surface views of a single unit truck with an embodiment of the device installed showing representative longitudinal positions of the forward portion.

FIGS. 13A-13C are lower surface views of a single unit truck with an embodiment of the device installed showing an alternate forward portion length and variations in inward extension.

FIGS. 14A-14C are lower surface views of a single unit truck an embodiment of the device installed showing an alternate forward portion shape and variations in longitudinal positions of the forward portion.

FIGS. 15A-15C are lower surface views of a single unit truck with an embodiment of the device installed showing an alternate forward portion shape and variations in inward extension.

FIGS. 16A-16C are lower surface views of a single unit truck with an embodiment of the device installed showing an alternate forward portion shape and variations in longitudinal positions of the forward portion.

FIG. 17 are side views of an alternate single unit truck without and with an embodiment of the device installed.

FIG. 18 are side views showing variations in gap distance for an alternate single unit truck with an embodiment of the device installed.

FIG. 19A shows an embodiment of the device installed on a single unit truck configured with a flat bed.

FIG. 19B shows an embodiment of the device installed on a single unit truck configured with a tank container.

FIGS. 20A and 20B are side views of an alternate single unit truck pulling a trailer without and with an embodiment of the device installed on the trailer.

FIGS. 21A and 21B are side and lower surface views of an articulated tractor-trailer truck system with an embodiment of the device installed on the trailer.

### DETAILED DESCRIPTION OF THE PREFERRED EMBODIMENTS

The following descriptions are of exemplary embodiments of the invention only, and are not intended to limit the scope, applicability or configuration of the invention in any way. Rather, the following description is intended to provide a convenient illustration for implementing various embodiments of the invention. As will become apparent, various changes may be made in the function and arrangement of the elements described herein without departing from the spirit and scope of the invention. For example, though not specifically described, many shapes, widths, leading edge shapes, spacing and orientation of the aft portion and forward portion of the structure and panels, candidate vehicles that can benefit from the device, fabrication means and material, attachments means and material should be understood to fall within the scope of the present invention.

Disclosed is an aerodynamic device for reducing drag on a ground vehicle, with the typical ground vehicle having a cab portion and a cargo portion aft of the cab portion, wherein the cab portion has at least two forward wheels, and wherein the cargo portion exterior defines a bottom surface, a first side with a first side surface, a second side with a second side surface, a front with a front surface and a rear with a rear surface, with the first and second sides spaced apart at a cargo portion width and with the bottom surface being above ground at a cargo portion height. An aspect of various embodiments of the aerodynamic device is that it comprises a first and second panel for mounting to the bottom surface of the cargo portion. For example, a first panel having a first outer surface, a first upper edge, and a first lower edge, the first panel comprising a first forward portion and a first aft portion. The first aft portion may be attached to the bottom surface of the cargo portion at the first side, extending downwardly from the cargo portion a desired first vertical distance. The first aft portion may be substantially coplanar with the first side surface of the cargo portion. The first forward portion may be attached to the bottom surface of the cargo portion forward of the aft portion, extending downwardly from the cargo portion, wherein the first forward portion extends inwardly from the cargo portion first side for a distance greater than 10% of the cargo portion width. The second panel may be similar to the first panel, but adapted for corresponding features on the second side.

The first and second lower edges are preferably aerodynamically sharp. The term “sharp” in reference to a panel edge means edge geometries that create sharp pressure gradients, and may, in the context of a cargo portion or area profile, be an edge geometry characterized by little or no curvature.

The first forward portion forms a first air dam and the second forward portion forms a second air dam. These air dams are configured such that when the ground vehicle is in forward motion generating a relative flow of air from front to hack, substantially all of the air flowing incident under the cargo portion front strikes the first and second air dams and is substantially redirected outboard along the first and second outer surfaces.

In seeking to reduce drag due to undercarriage structure, blocking the streamwise flow from the front of a cargo portion as well as from the sides is important for effectiveness. The inventors have discovered that most vehicles admit a flow from the front on each side of the front of the cargo portion for at least about 10% of the vehicle width. A ratio based on vehicle width accommodates variations in vehicle configuration; it is believed that even the more streamlined cab and trailer configurations admit this degree of flow due to forward wheel positioning. For example, in the case of a light cargo ground vehicle, the maximum width may be about 102 to 108 inches; 10% of the width from each side is about 20-22 inches of the front, which would-correspond to the minimal width of a single forward wheel on each side. It is contemplated that most configurations admit front flow for considerably more than about 10% of the vehicle width from each side of the front of a cargo portion. For example, some vehicles with open tractor carriage at the fifth wheel coupling might expose the entire front, and may be well suited for air dams that extend inwardly for, a distance of 50% each for 100% total coverage.

Referring now in detail to the drawings, like numerals herein designate like numbered parts in the figures.

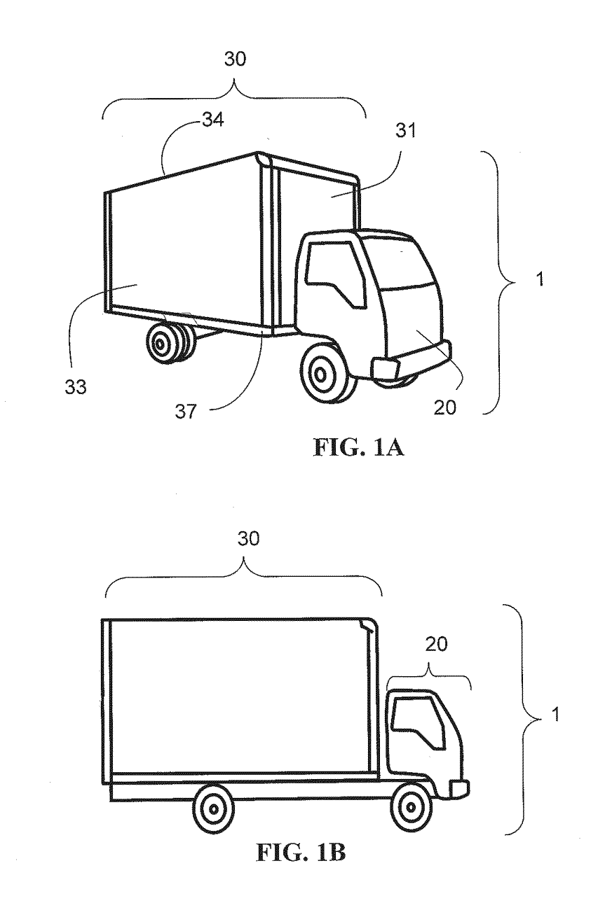

FIG. 1A and FIG. 1B shows a typical ground vehicle or single unit truck system 1, for example, comprised of a cab portion 20 that houses the power system and space for an operator and a van type cargo portion 30. The cargo portion 30 is comprised of a front surface 31, side surfaces 32 (not shown) and 33, a top surface 34, a rear surface 36 (not shown), and a bottom or lower surface 37. FIG. 1A shows an oblique front view and FIG. 1B shows a side view of a typical single unit truck 1 with a van cargo portion 30.

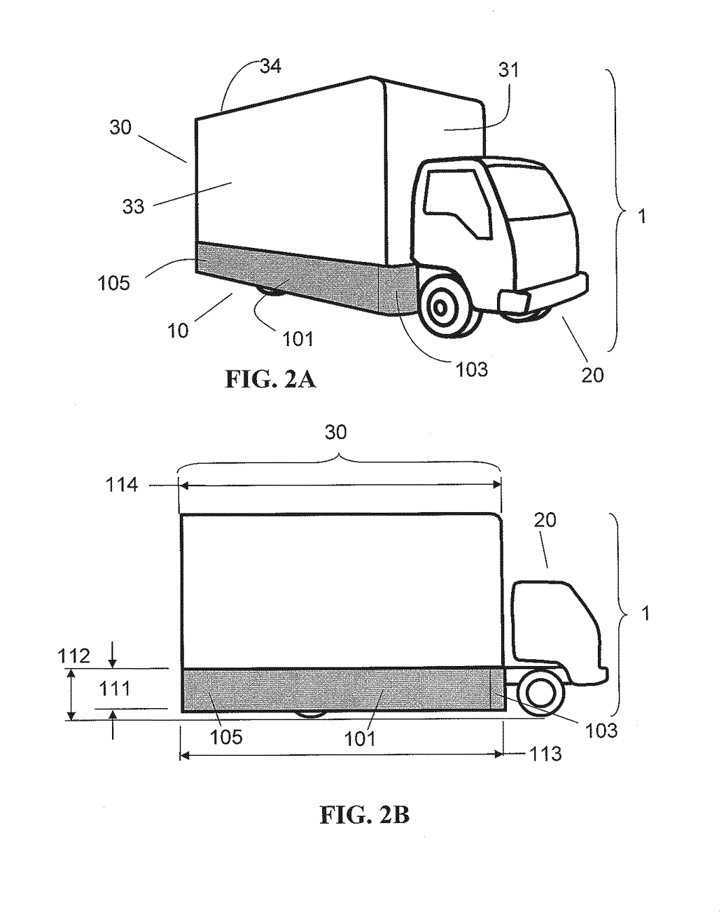

FIG. 2A and FIG. 2B shows a typical single unit truck system 1, for example, comprised of a cab portion 20 that and a van type cargo portion 30 with an embodiment of the device 10 installed. The cargo portion 30 is comprised of a front surface 31, side surfaces 32 (not shown) and 33, a top surface 34, a rear surface 36 (not shown), and a lower or bottom surface 37 (not shown). FIG. 2A shows an oblique front view and FIG. 2B shows a side view of a typical single unit truck 1 with a van cargo portion 30 with the aerodynamic device 10 installed. The device 10 is comprised of two structures or a first panel 101 and a second panel 102 (not shown) that extend downward from the vehicle cargo portion 30 bottom surface 37. The downward extent 111 of device 10 is typically anywhere less than about 90 to 95% of the distance from the bottom surface 37 to the surface or road that the vehicle is moving over 112 (or cargo portion height). Each of the first and second panels, 101 and 102, have a frontward or forward portion, 103 and 104, and an aft or rearward portion 105 and 106. The forward portion, 103 and 104, of each structure extends inward and has significant forward projected area. The aft portion, 105 and 106, of each structure is approximately aligned in a plane that is substantially parallel with the vehicle centerline and has minimal forward projected area. The longitudinal length 113 of device 10 is typically at least about 30% of the vehicle cargo length 114 and not greater than the length of the host vehicle 1. Of course, the device 10 may be used with various configured cargo systems such as flat beds, tanks, reefers, and various size trucks and pull trailers or vehicles as well, in which the plane of side surfaces 32 or 33 may be somewhat notional. Each of the first and second panels 101 and 102 may have a width 111 and a length 113. The leading edge and trailing edge of each structure may be swept. To facilitate access to the vehicle undercarriage, each portion or panel of the device 10 may be either removed through a quick disconnect mechanism or folded out of the way, so as to be substantially adjacent and proximate the bottom surface 37 or side surfaces 32 and 33. The length 113 of each structure, 101 and 102, of the device 10 is determined by the geometric characteristics of the vehicle 1, the operational requirements of the vehicle 1, and the maintenance requirements of the vehicle 1. It is desirable that each structure, 101 and 102, of the device 10 extend between the aft most portion of the vehicle 1 and a point aft of the forward wheel set. The width 113 of each panel, 101 and 102, of the device 10 is determined by the geometric characteristics of the vehicle 1, the operational requirements of the vehicle 1 and the maintenance requirements of the vehicle 1. The type, size, and structure of the hardware used to attach the device 10 to the vehicle 1 is determined by the geometric characteristics of the vehicle 1, the operational requirements of the vehicle 1, and the maintenance requirements of the vehicle 1.

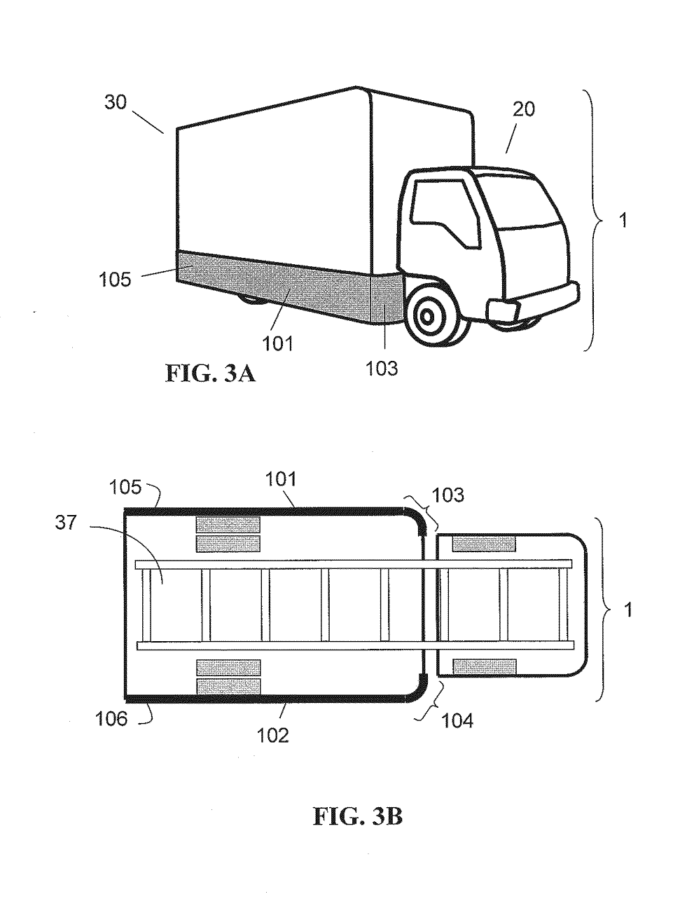

FIG. 3A and FIG. 3B shows a typical single unit truck system 1, for example, comprised of a cab portion 20 that and a van type cargo portion 30 with an embodiment of the device 10 installed. FIG. 3A shows an oblique front view and FIG. 3B shows a lower surface view of this typical single unit truck 1 with device 10 installed. The device 10 is comprised of first and second panels 101 and 102 that extended downward from the vehicle bottom surface 37. Each of the first and second panels, 101 and 102, have a forward portion, 103 and 104, and an aft portion 105 and 106. The forward portion, 103 and 104, of each penal 101, 102, extends inward and has significant forward projected area. The aft portion, 105 and 106, of each structure 101, 102, is approximately aligned in a plane that is parallel with the vehicle centerline and has minimal forward projected area.

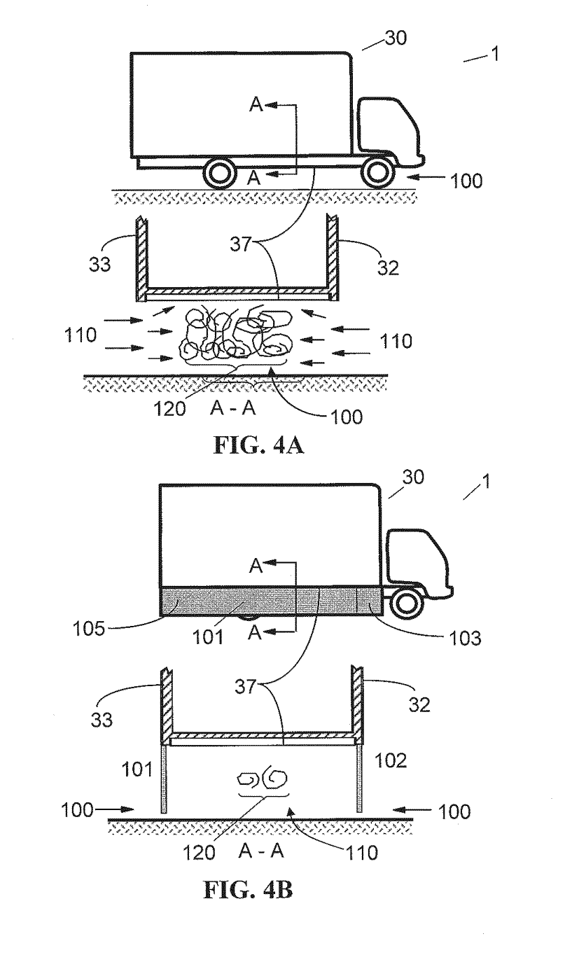

FIGS. 4A and 4B show flow patterns in the undercarriage region of a ground vehicle 1 with and without device 10 installed. In FIG. 4A and FIG. 4B, the airflow about the vehicle 1 and in the undercarriage region is represented by arrow-tipped lines 100 and swirl structures 110. The arrow-tipped lines 100 represent the free stream flow entering the undercarriage region. The non-arrow-tipped circular lines 110 represent rotational, random, unsteady eddy flow.

FIG. 4A shows a cross-section view, in a plane perpendicular to the ground, of the undercarriage of a vehicle cargo portion 30 with side surface 32 and 33 and a bottom surface 37. FIG. 4A also shows the undercarriage flow 100 and 110, without the device 10 installed. For a vehicle 1 moving over a surface or road, the free stream flow 100 enters the undercarriage region from the front of the vehicle 1 and from the side of the vehicle 1. The freestream flow 100 interacts with the various vehicle components and becomes unstructured and dynamic and includes random size and strength eddies 110. The dynamic, random undercarriage flow interacts with the vehicle undercarriage structures resulting in a large drag force.

FIG. 4B shows a cross-section view, in a plane perpendicular to the ground, of the undercarriage of a vehicle cargo portion 30 with side surface 32 and 33 and a bottom surface 37 and the first and second panels, 101 and 102 comprising an embodiment of the device 10. Each structure or panel, 101 and 102, of the device 10 contains two primary surfaces; a forward portion, 103 and 104, and an aft portion, 105 and 106. FIG. 2B also shows the undercarriage flow 110 with an embodiment of the device 10 installed. For a vehicle 1 with the device 10 installed there is negligible undercarriage flow and thus negligible undercarriage drag. The dramatic reduction in undercarriage flow results from the flow control by both the forward portions, 103 and 104, and the aft portions, 105 and 106, of the device 10. The forward portions, 103 and 104, of the device 10 efficiently redirects the flow, passing under and around the sides of the forward part of the vehicle 1, laterally outboard of the vehicle cargo portion 30. The aft portions, 105 and 106, of the device 10 efficiently blocks the flow that would otherwise enter the undercarriage-region from the side of the vehicle 1. The forward and aft portions work together for effectiveness.

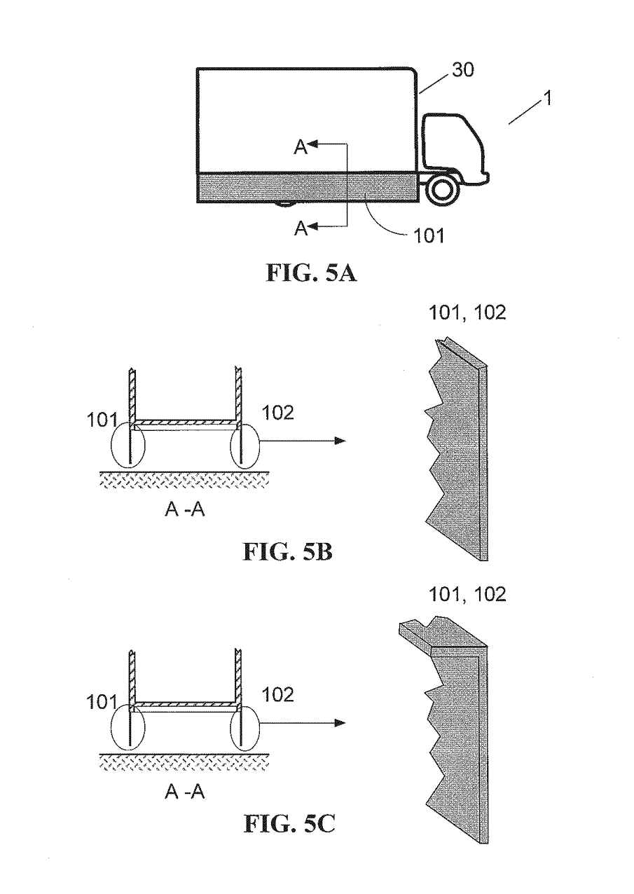

FIG. 5 shows two panel-concepts of device 10. The figure shows a cross-section view A-A, in a plane perpendicular to the ground, of the undercarriage of a cargo portion 30 with the first and second panels 101 and 102 of an embodiment of the device 10. FIG. 5B shows each structure 101 and 102 of the device 10 may be constructed as a single vertical panel without an attachment element. FIG. 5C shows each structure 101 and 102 of the device 10 may be constructed as an inverted L-shaped panel with an integrated upper attachment element. The depicted panel concepts shown are examples only, additional panel concepts may also be considered. The example panel concepts shown, as well as other concepts, may be used on either the forward portions, 103 and 104, or the aft portions, 105 and 106, or both portions of the device 10.

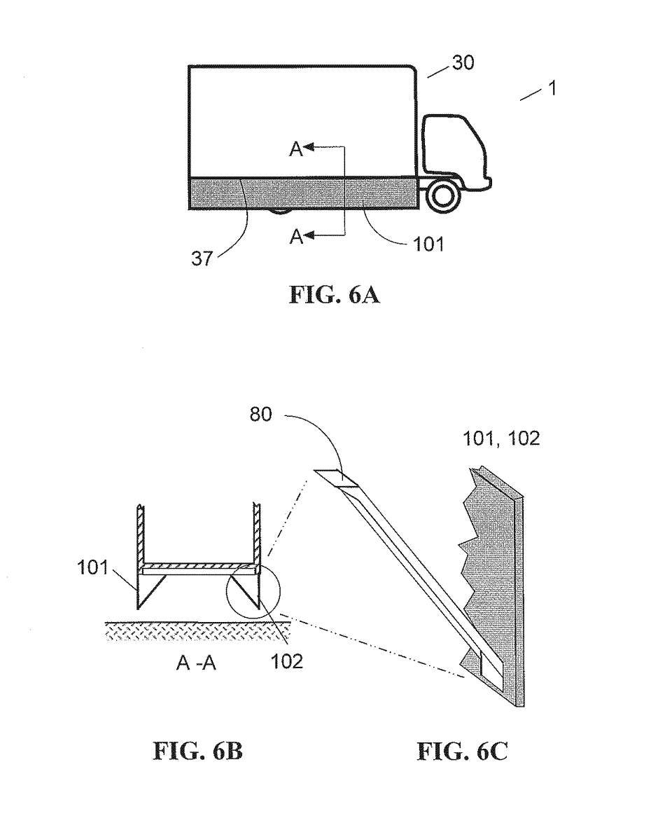

FIG. 6 shows a support concept comprising an embodiment of the device 10. The figure shows a cross-section view A-A, in a plane perpendicular to the ground, of the undercarriage of a cargo portion 30 with the first and second panels 101 and 102 of the device 10. The concept shown in FIG. 6C is for an angled bracket 80 connected to the bottom surface 37 of vehicle 1 that may be used to support each structure 101 and 102 of the device 10. Common approaches would argue against such a support due to the increase in drag, which would be a problem without device 10. The depicted support concept is an example only, additional support concepts may also be considered. The example support concept shown, as well as other support concepts, may be used on either the forward portions, 103 and 104, or the aft portions, 105 and 106, or both portions of the device 10.

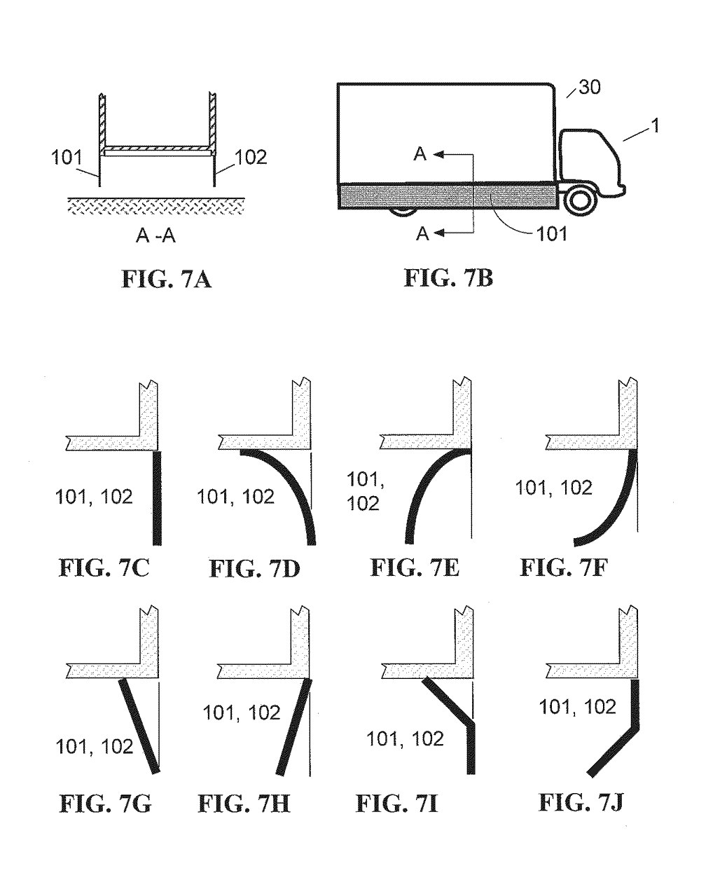

FIGS. 7A-7J show eight panel shape concepts comprising embodiments of the device 10. The figure shows a cross-section view A-A, in a plane perpendicular to the ground, of the undercarriage of a cargo portion 30 with the first and second panels 101 and 102 comprising an embodiment of the device 10. FIG. 7C shows that each structure 101 and 102 of the device 10 may be constructed as a single vertical panel. FIG. 7D shows that each structure 101 and 102 of the device 10 may be constructed as an outwardly curved panel with an inset upper edge. FIG. 7E shows that each structure 101 and 102 of the device 10 may be constructed as an inwardly curved panel. FIG. 7F shows that each structure 101 and 102 of the device 10 may be constructed as an alternate inwardly curved panel. FIG. 7G shows that each, structure 101 and 102 of the device 10 may be constructed as an outwardly angled panel with an inset upper edge. FIG. 7H shows that each structure 101 and 102 of the device 10 may be constructed as an inwardly angled panel. FIG. 7I shows that each structure 101 and 102 of the device 10 may be constructed as an outwardly bent, panel with an inset upper edge. FIG. 7J shows that each structure 101 and 102 of the device 10 may be constructed, as an inwardly bent panel. The depicted panel shape concepts shown are examples only, additional panel shape concepts may also, be considered. The example panel shape concepts shown as well as other shape concepts may be used on either the forward portions, 103 and 104, or the aft portions, 105 and 106, or both portions of the subject device 10.

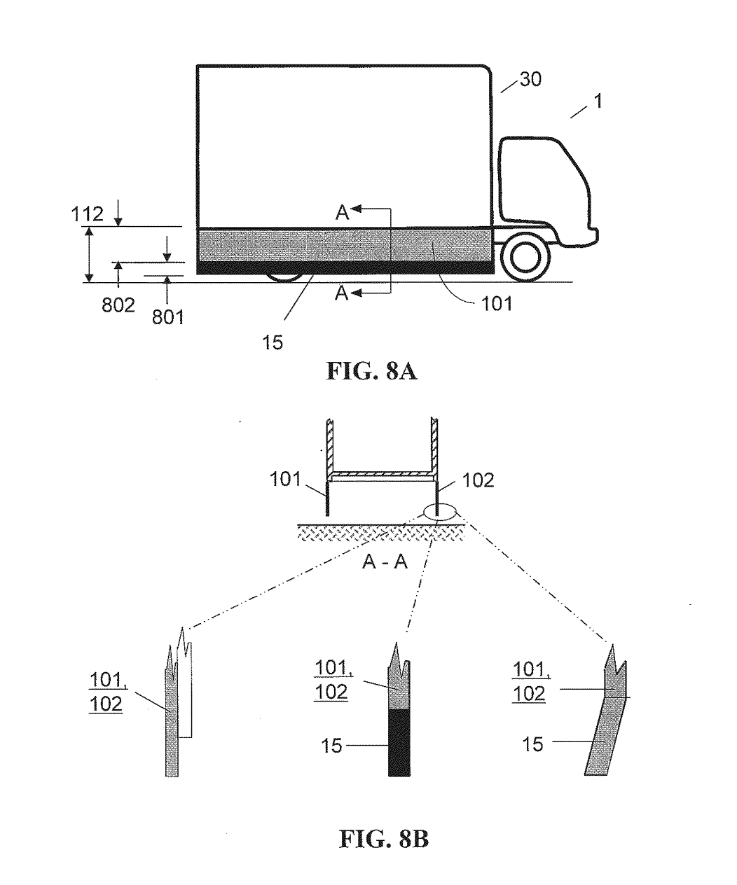

FIG. 8A shows a side view of a single unit vehicle 1 with an embodiment of the device 10 installed. FIG. 8A shows the left side panel 101 of the device 10 (i.e., looking aft) with an alternate left side lower edge 15. This embodiment of device 10 includes a left side structure 101 and a right side structure 102 and an alternate left side lower edge 15 and an alternate right side lower edge 15. FIG. 8B shows three representative concepts for the alternate lower edges, 15 and 15. The alternate lower edges may be slidable, flexible, and/or spring loaded. Additional concepts may also be considered based upon operational, maintenance, and performance considerations. The alternate edge width 801 is less than the device width 802 and the combination of the alternate edge width 801 and the device width 802 is less than the distance to the ground 112.

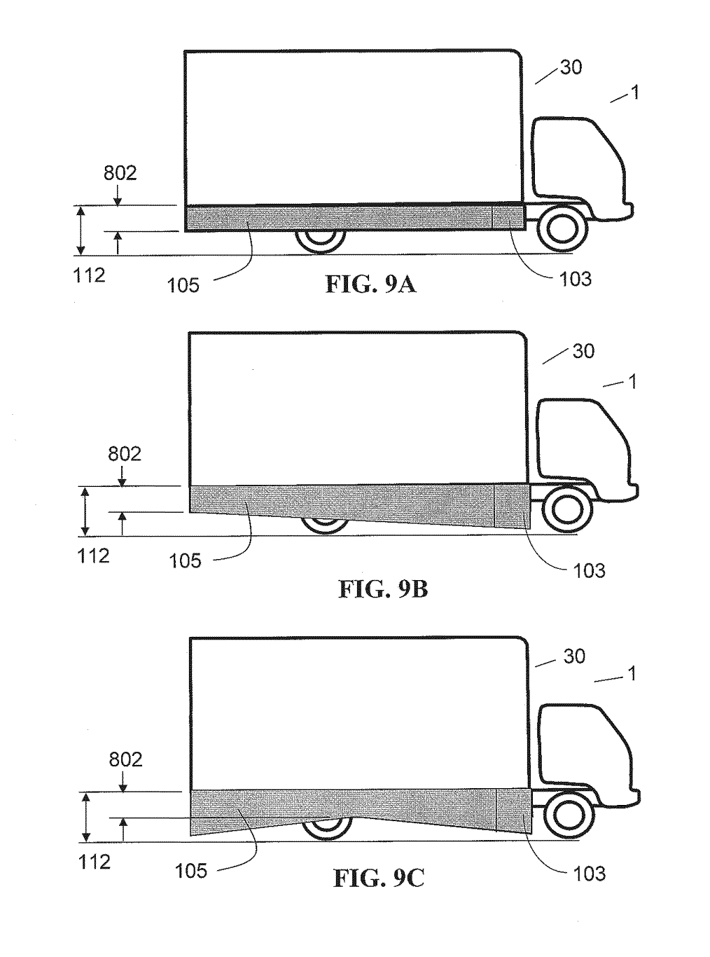

FIGS. 9A-9C shows a side view of a single unit truck or vehicle 1 with embodiments of the device 10 installed. FIG. 9A show the left side panel 101 of the device 10 with a reduced width 802 that is constant along the length of the device 10. FIGS. 9B and 9C show the left side structure 101 of the device 10 with a varying width 802 along its length. FIGS. 9B and 9C show that the width 802 of the forward portions, 103 and 104, differs from the width 802 of the aft portions, 105 and 106, of the device 10. The depicted width variation concepts shown are examples only, additional panel width variation concepts may also be considered. The example panel width variation concepts shown as well as other concepts may be used on either the forward portions, 103 and 104, or the aft portions, 105 and 106, or both portions of the device 10.

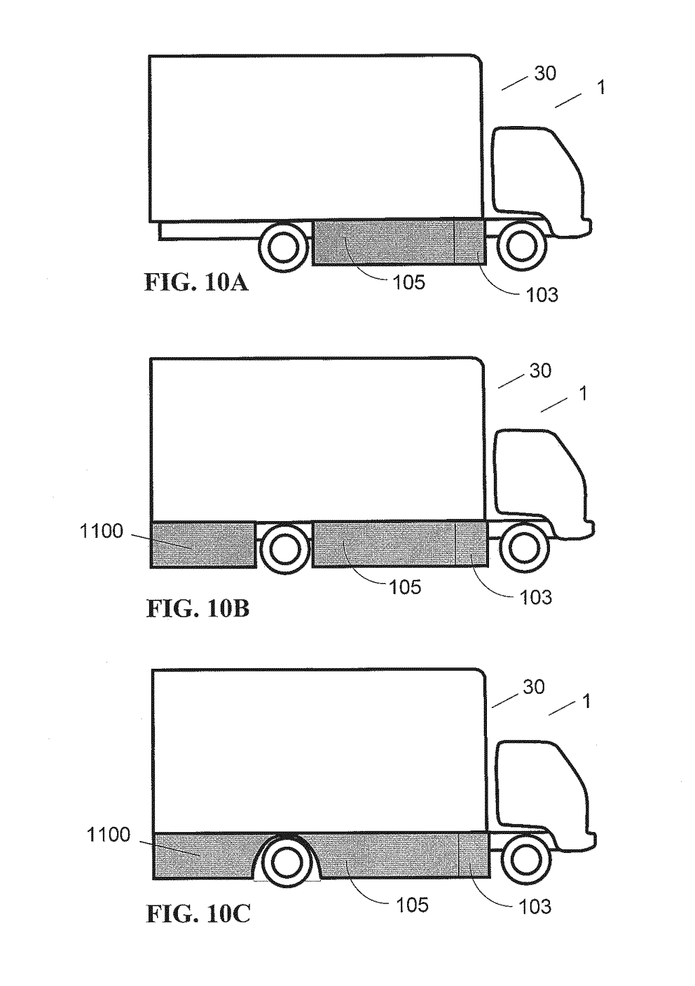

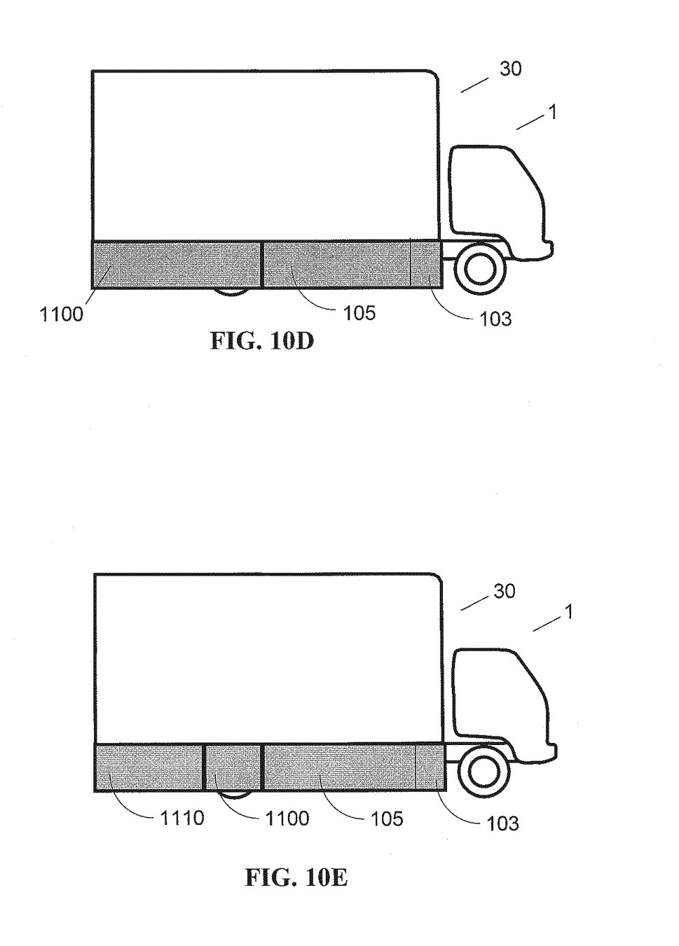

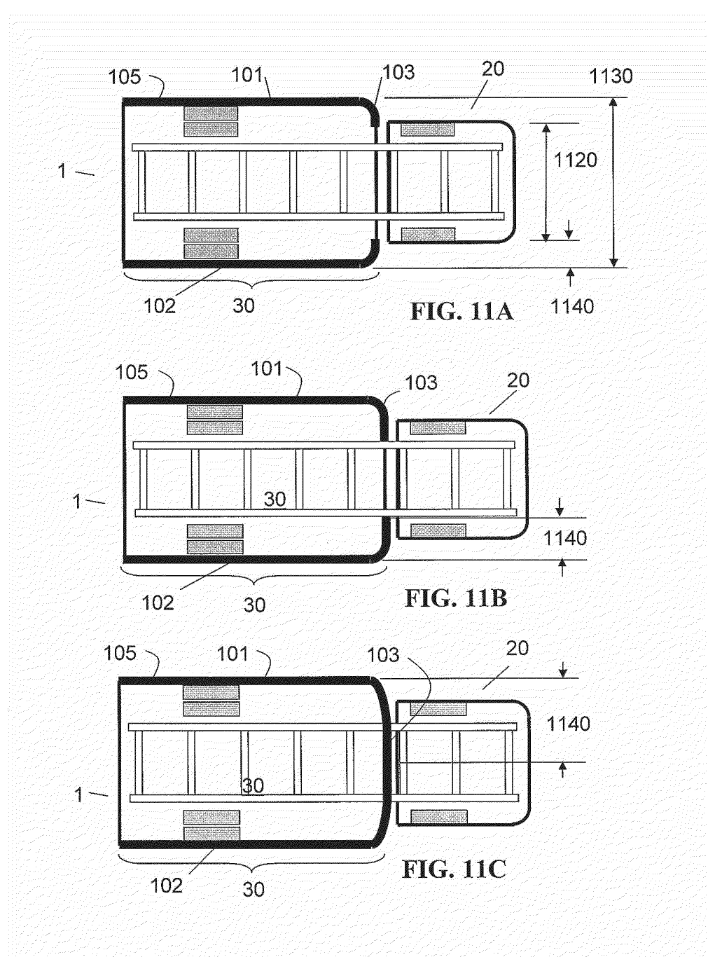

FIGS. 10A-10E show a side view of a single unit vehicle 1 with several versions of the device 10 installed. FIG. 10A show the left side structure 101 of the device 10 with a reduced length aft portion 105 of device 10. FIGS. 10B-10E show the left side panel 101 of the device 10 with a reduced length aft portion 105 combined with additional portions or aft panels 1100 and 1110. FIGS. 10B and 10C show the aft portion 105 terminates prior to the rear wheels, and an additional aft panel 1100 is positioned aft of the rear wheel system. FIG. 10D show the aft portion 105 terminates prior to the rear wheels and an additional aft panel 1100 is positioned immediately aft of the aft portion 105 and extends aft over the rear wheel system to the trailing edge of the vehicle 1. FIG. 10E show the aft portion 105 terminates prior to the rear wheels and two additional panels 1100 and 1110 are positioned aft of the aft portion 105 of device 10. The depicted length-variation concepts shown are examples only, additional-panel length variation concepts may also be considered. The example panel length variation concepts shown as well as other concepts, may be used on either the forward portions, 103 and 104, or the aft portions, 105 and 106, or both portions of the device 10.

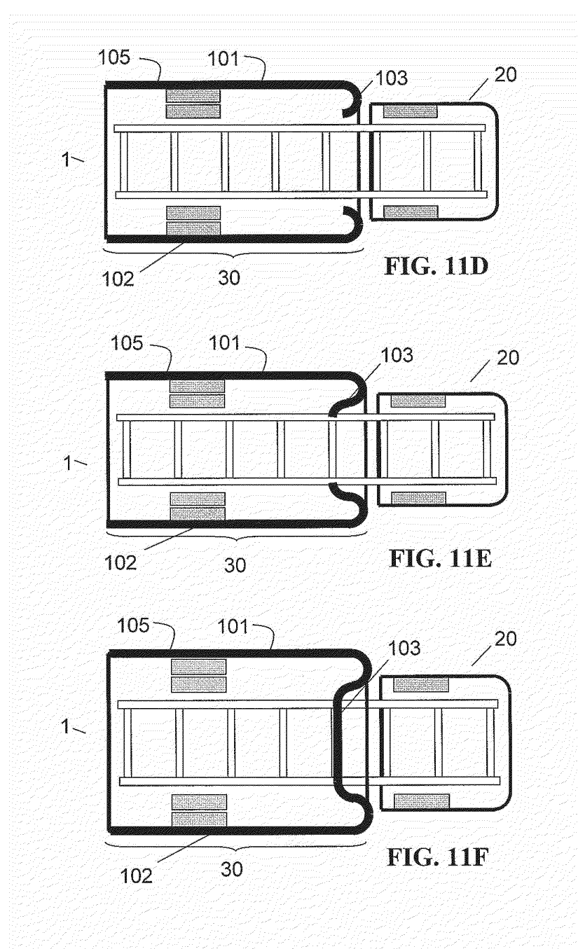

FIGS. 11A-11F shows a lower surface view of a single unit vehicle 1 with an embodiment of the device 10 installed. A typical single unit truck or vehicle 1 is comprised of a cab portion 20 and a cargo portion 30. The cargo portion width 1130 may differ from the cab portion width 1120. FIGS. 11A-11C show a variation in the inward extension 1140 of the forward portions, 103 and 104, of the device 10. FIG. 11A show a lower surface view of a single unit vehicle 1 with the cab portion width 1120 less than the cargo portion width 1130. The forward portion, 103 and 104, of the panels, 101 and 102, extend inward a distance 1140, that equals one half the difference between the cab portion width 1120 and cargo portion width 1130. FIG. 11B show a lower surface view of a single unit vehicle 1 with forward portion, 103 and 104, extending inward a distance 1140, that is greater than one half the difference between the cab portion width 1120 and cargo portion width 1130. FIG. 11C show a lower surface view of a single unit vehicle 1 with forward portion, 103 and 104, extending inward to the vehicle center line a distance 1140. The depicted inward extensions are examples only, additional inward extension lengths may also be considered.

FIGS. 11D-11F show a lower surface view of a single unit vehicle 1 with the embodiments of the device 10 installed. FIGS. 11A-11C show an alternate variation in the forward portion, 103 and 104, of device 10.

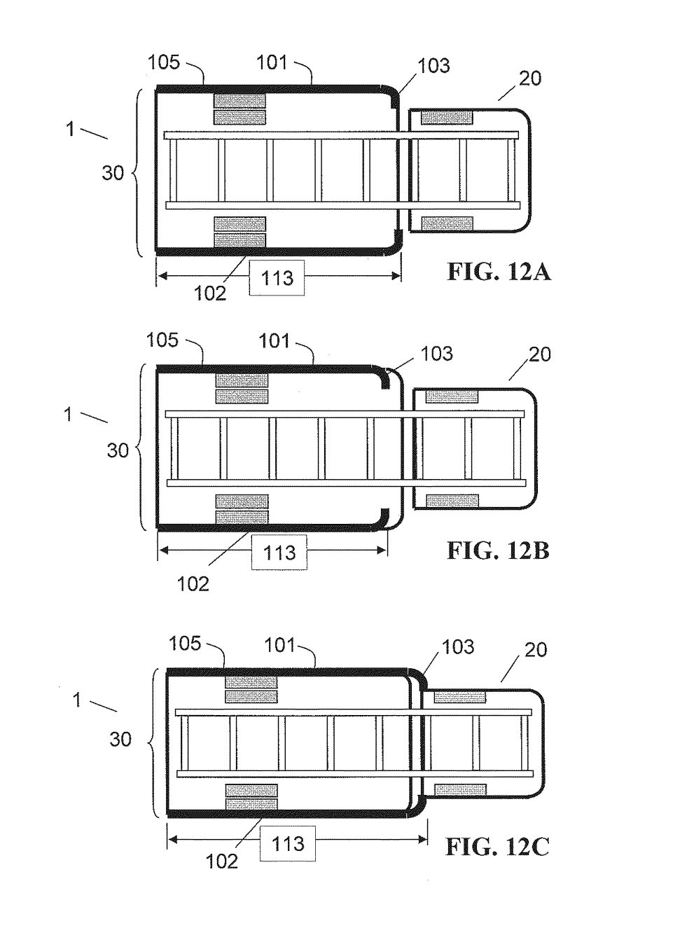

FIGS. 12A-12C shows a lower surface view of a single unit 1 comprised of a cab portion 20 and a cargo portion 30 with embodiments of the device 10 installed. FIGS. 12A-12C show a variation in the length 113 of the first and second panels, 101 and 102, of the device 10. FIG. 12A show the device 10 has length 113 that is equivalent to the length of the cargo portion 30. FIG. 12B show the device 10 has length 113 that is less than the length of the cargo portion 30. FIG. 12C show the device 10 has length 113 that is greater than the length of the cargo portion 30. The depicted lengths 113 of the device 10 are examples only, additional lengths may also be considered in which the forward portion, 103 and 104, and or the aft portion, 105 and 106 are lengthened.

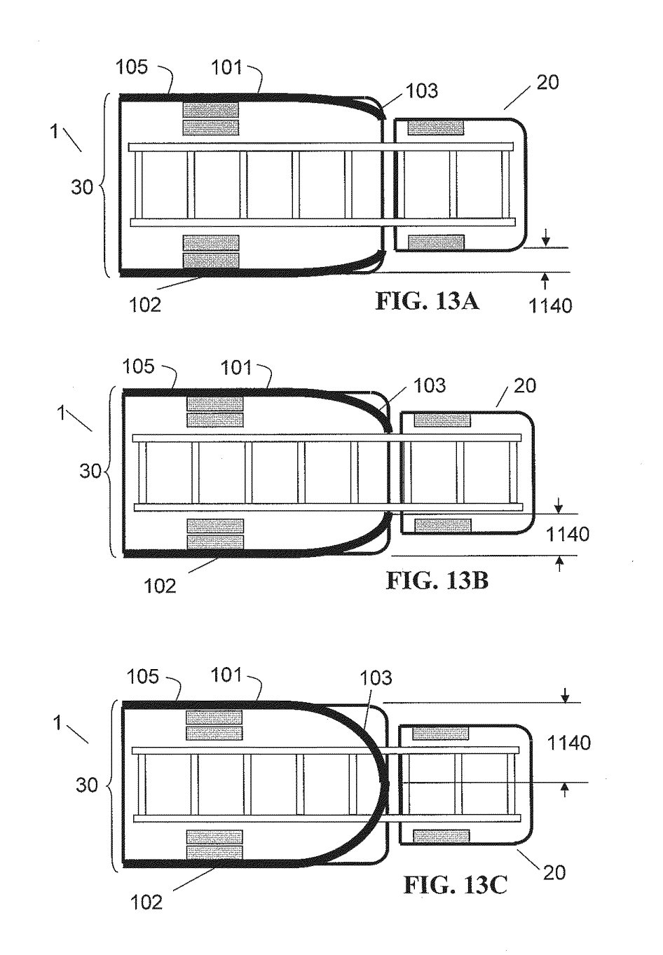

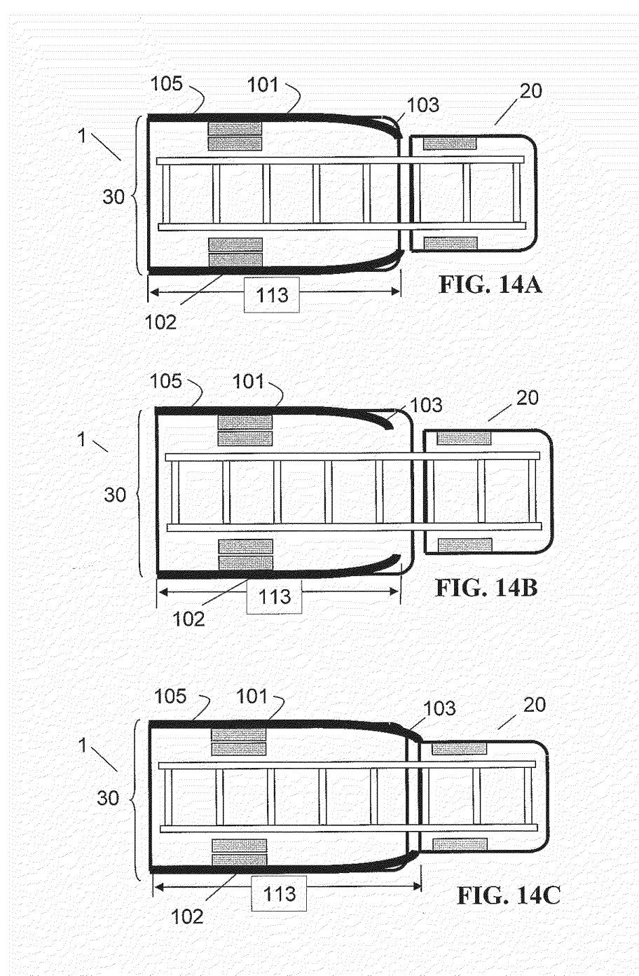

FIGS. 13A-13C shows a lower surface view of a single unit truck 1 comprised of a cab portion 20 and a cargo portion 30 with embodiments of the device 10 installed. FIGS. 13A-13C show a variation in the shape and inward extension 1140 of the forward portion, 103 and 104, of the device 10. The device 10 shown in FIGS. 13A-13C may have a forward portion, 103 and 104, that has a length that is equivalent to the length of the aft portion, 105 and 106. The depicted lengths of the forward portion, 103 and 104, and the aft portion, 105 and 106 of the device 10 are examples only, additional lengths may also be considered. Also shown here is that the forward portions 103 and 104 of the first and second panels extend inwardly at an angle with respect to a transverse axis, so as to present a substantially transverse swept leading surface.

FIGS. 14A-14C show a lower surface view of a single unit vehicle 1 comprised of a cab portion 20 and a cargo portion 30 with embodiments of the device 10 installed. FIGS. 14A-14C show an alternate embodiment of the device 10 and show a variation in the length 113 of the first and second panels, 101 and 102, of the device 10. FIG. 14A shows the device 10 has length 113 that is equivalent to the length of the cargo portion 30. FIG. 14B shows the device 10 has length 113 that is less than the length of the cargo portion 30. FIG. 14C shows the device 10 has length 113 that is greater than the length of the cargo portion 30. The depicted lengths 113 of the device 10 are examples only, additional lengths may also be considered in which the forward portion, 103 and 104, and or the aft portion, 105 and 106 are lengthened.

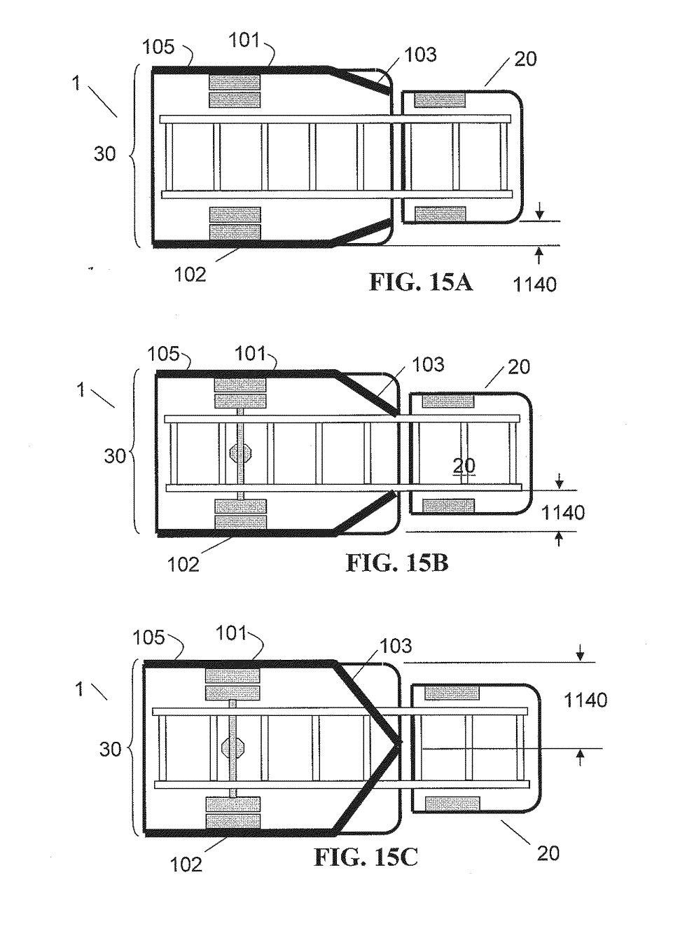

FIGS. 15A-15C show a lower surface view of a single unit vehicle 1 comprised of a cab portion 20 and a cargo portion 30 with embodiments of the device 10 installed. FIGS. 15A-15C show a variation in the shape and inward extension 1140 of the forward portion, 103 and 104, of the device 10. The device 10 shown in FIGS. 15A-15C has a linear forward portion, 103 and 104, that has a length that is less than the length of the aft portion, 105 and 106. The depicted lengths of the forward portion, 103 and 104, and the aft portion, 105 and 106 of the device 10 are examples only, additional lengths may also be considered. Also shown here is another example in which the forward portions 103 and 104 of the first and second panels extend inwardly at an angle with respect to a transverse axis, so as to present a substantially transverse swept leading surface. Such arrangements may be particular useful for vehicles 1 in which cab portion 20 exposes much of the area under cargo portion 30 to incident air flow, aiding in redirecting air outboard along the first and second outer surfaces of the device 10.

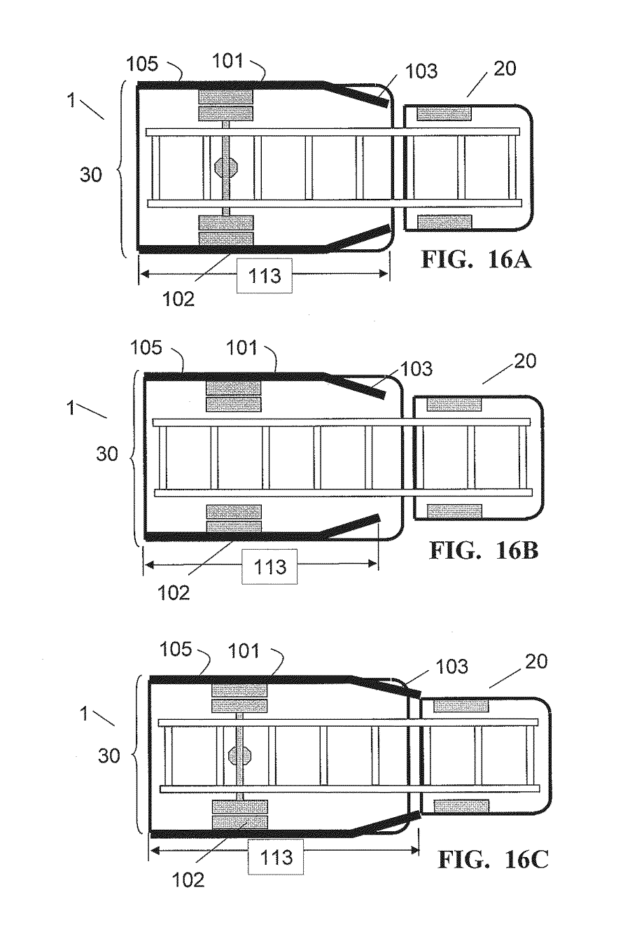

FIGS. 16A-16C show a lower surface view of a single unit vehicle 1 comprised of a cab portion 20 and a cargo portion 30 with embodiments of the device 10 installed. FIGS. 16A-16C show an alternate embodiment of the device 10 with a variation in the shape and length 113 of the first and second panels, 101 and 102, of the device 10. FIG. 16A shows the device 10 having a linear forward portion, 103 and 104, and a length 113 that is equivalent to the length of the cargo portion 30. FIG. 16B shows the device 10 having a linear forward portion, 103 and 104, and a length 113 that is less than the length of the cargo portion 30. FIG. 14C shows the device 10 having a linear forward portion, 103 and 104, and a length 113 that is greater than the length of the cargo portion 30. The depicted lengths 113 of the device 10 are examples only, additional lengths may also be considered in which the forward portion, 103 and 104, and or the aft portion, 105 and 106 are lengthened.

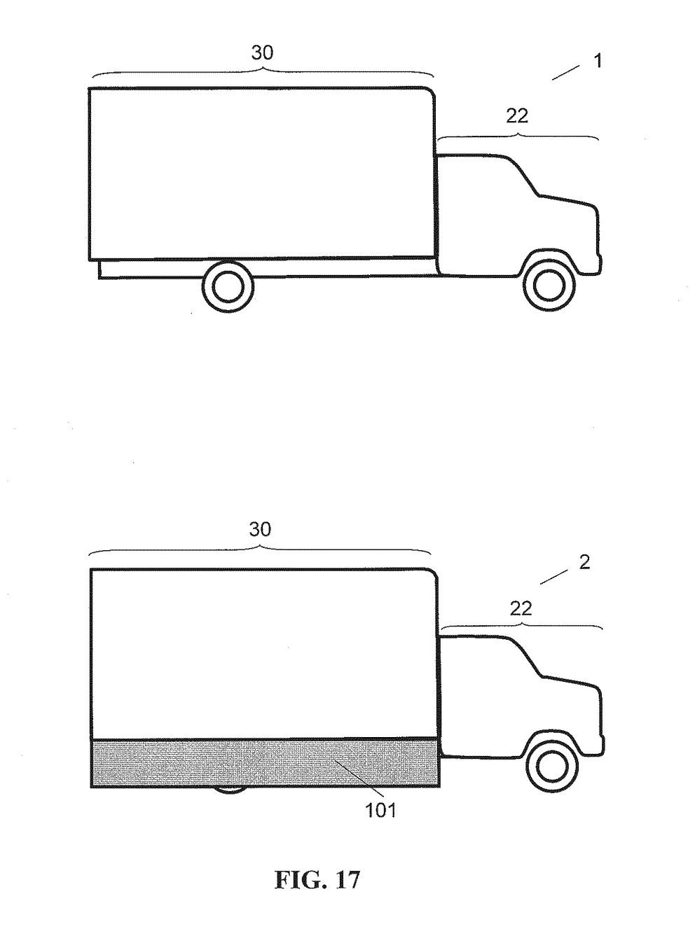

FIG. 17 shows side views of an alternate single unit truck system or vehicle 2 configured with a traditional type cab portion 22 and a van type cargo portion 30 with and without an embodiment of the device 10 installed. The device 10 is comprised of first and second panels, a left side first panel 101 and a right side second panel 102. The device 10 extends downward from the vehicle bottom surface.

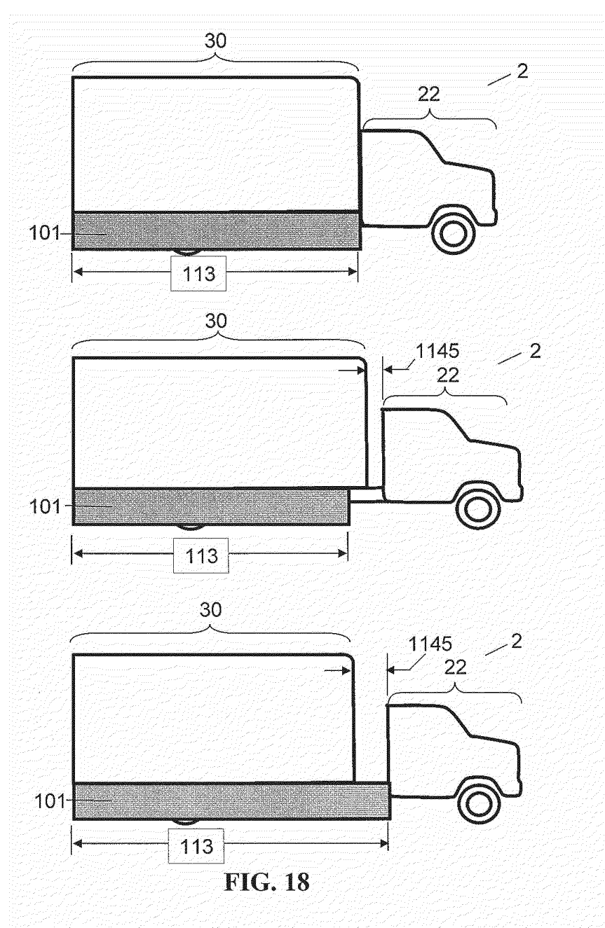

FIG. 18 shows side views of an alternate single unit truck system or vehicle 2 configured with a traditional type cab portion 22 and a van type cargo portion 30 with alternate versions of the device 10 installed. FIG. 18 shows a device 10 having a length 113 and the cab portion 22 may be separated from the cargo portion 30 a distance 1145. Alternate versions of the device 10 have a length 113 equal to the cargo portion 30 length, less than the cargo portion 30 length, and greater than the cargo portion 30 length.

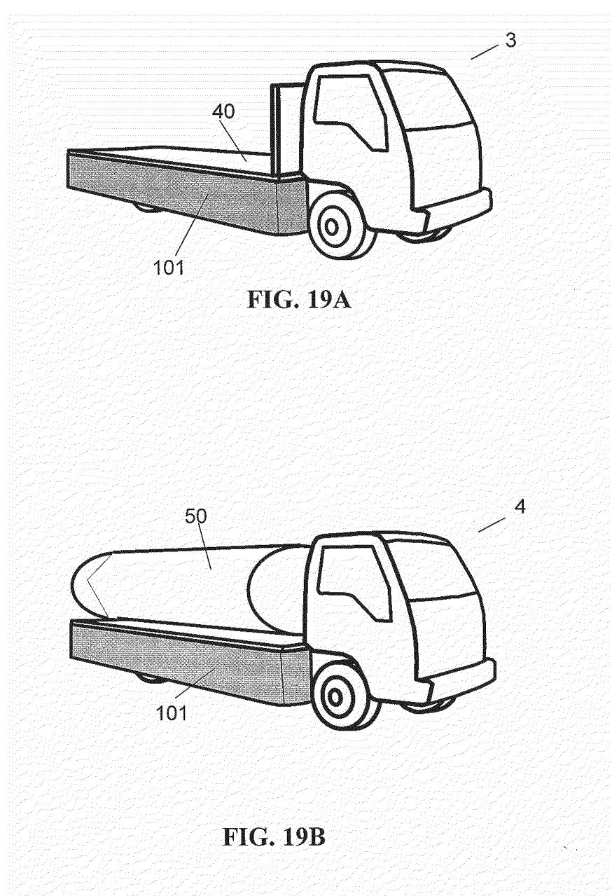

FIGS. 19A and 19B show oblique front side views of alternate single unit truck system or vehicles 3 and 4 with an embodiment of the device 10 installed. FIG. 19A shows a single unit vehicle 3 with a flat bed 40 and FIG. 19B shows a single unit truck 4 configured with a tank type 50.

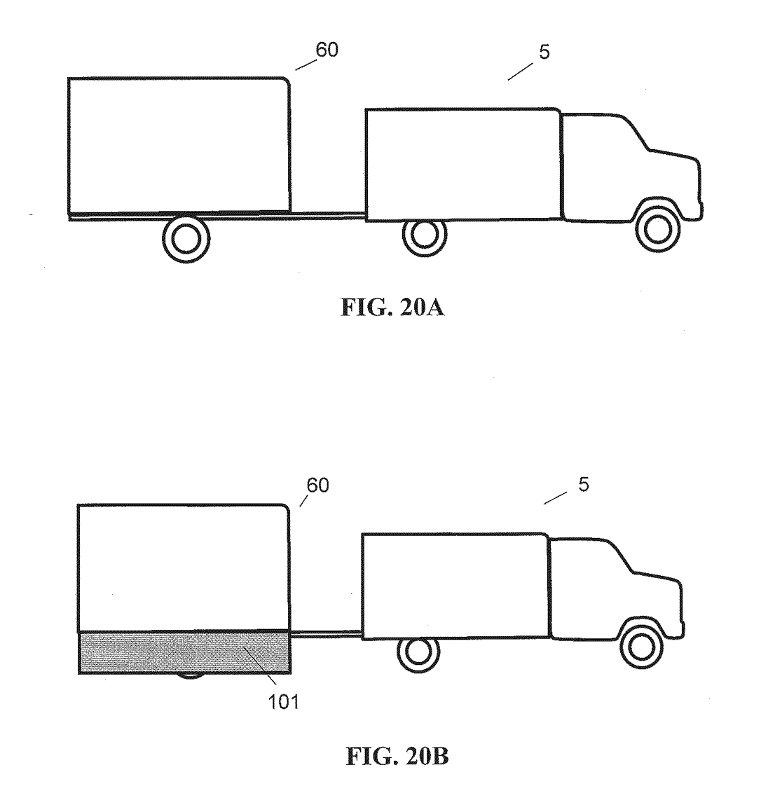

FIG. 20 shows side views of a combination vehicle comprised of a powered vehicle 5 pulling a trailer 60 with and without an embodiment of the device 10 installed on the pulled trailer or cargo portion 60. The device 10 has first and second panels, a left side structure 101 and a right side structure 102. The device 10 extends downward from the trailer cargo portion 60 lower or bottom surface.

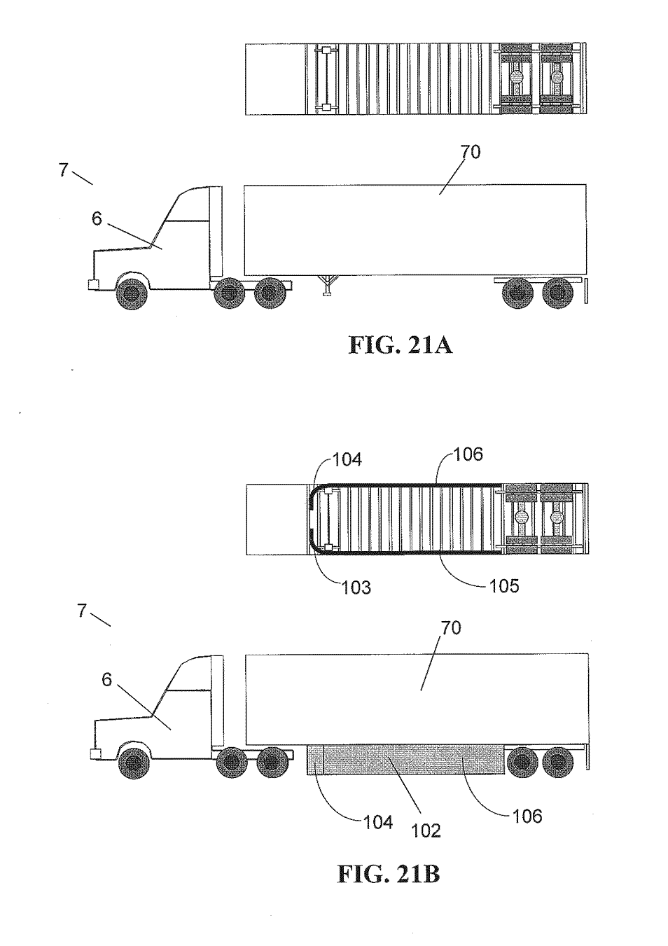

FIGS. 21A and 21B show side and lower surface views of an alternate combination vehicle 7 comprised of a powered vehicle 6 pulling a trailer type vehicle or cargo portion 70 with and without an embodiment of the device 10 installed on the pulled trailer or cargo portion 70. The device 10 has first and second panels, a left side first panel 101 and a right side second panel 102. The device 10 extends downward from the trailer or cargo portion 70 surface.

From the description provided above, a number of features of the dam-skirt aerodynamic fairing become evident:

The various embodiments of device 10 provide a process to reduce the drag of a ground vehicle. The following aspects apply to at least one or more embodiments of the device 10:
(a) The device uses flow control shaping to reduce undercarriage flow and reduce drag.
(b) The device reduces the aerodynamic drag and improves the operational efficiency of ground vehicles.
(c) The device reduces the aerodynamic drag and improves the fuel efficiency of ground vehicles.
(d) The device conserves energy and improves the operational efficiency of ground vehicles.
(e) The device reduces the aerodynamic drag without a significant geometric modification to existing ground vehicles.
(f) The device may be easily applied to any existing ground vehicle or designed into any new ground vehicle.
(g) The device may be efficiently operated with a limited number of components.
(h) The device permits the matching of complex surface shapes by the shaping and placement of the components.
(i) Significant reductions in drag force may be achieved with a range of vertical spacing between the lower edge of the device and the road surface.
(j) The structure, placement, and shape of each component may be adapted to meet specific performance or vehicle integration requirements.
(k) The shape of each surface may be linear or complex to meet specific performance or vehicle integration requirements.
(l) The lower edge shape of each surface may be planar or complex to meet specific performance or vehicle integration requirements.
(m) The trailing edge shape of each surface may be linear or complex to meet specific performance or vehicle integration requirements.
(n) Each component of the device may be optimally positioned on the vehicle undercarriage.
(o) The device minimizes weight and volume requirements within the vehicle.
(p) The device has minimal maintenance requirements.
(q) The device has minimal impact on operational and use characteristics of the vehicle door system.
(r) The device provides for maximum safety of vehicle operation.

A dam-skirt aerodynamic fairing device may be used to easily and conveniently reduce aerodynamic drag on any ground vehicle for the purposes of improving the operational performance of the vehicle. For example, ground vehicles may include buses, rail cars, automobiles, etc., so long as such vehicle would benefit from the present invention's implementation of the flow control concepts and ground effect interference.

Although the description above contains many specificities, these should not be construed as limiting the scope of the invention but as merely providing illustration of some embodiments of this invention. For example, the forward and aft portion surfaces can be composed of various planar shapes such as ellipsoid, quadratic, and the like; the forward and aft portion surfaces can be rotated from the vertical axis or may be curvilinear surfaces that are parallel with the axis of the vehicle; the thickness and width of each surface can vary along the length; the material can be any light-weight and structurally sound material such as wood, plastic, metal, composites, and the like; the substrate can be any metal, wood, plastic, composite, rubber, ceramic, and the like; the application surface can be that of a metal, wood, plastic, composite, rubber, ceramic, and the like. The attachment and actuation hardware can be either conventional off the shelf or designed specifically for the device. Further, the device may be incorporated or integrated within the structure of the vehicle, so as to require no separate attachment.

The invention has been described relative to specific embodiments thereof and relative to specific vehicles, however, it is not so limited. The invention is considered applicable to any road vehicle including race cars, automobiles, trucks, buses, trains, recreational vehicles and campers. The invention is also considered applicable to non-road vehicles such as hovercraft, watercraft, aircraft and components of these vehicles. It is to be understood that various modifications and variation of the specific embodiments described herein will be readily apparent to those skilled in the art in light of the above teachings without departing from the spirit and scope.

What is claimed is:

1. An aerodynamic device for reducing drag on a ground vehicle, the ground vehicle having a cab portion and a cargo portion aft of the cab portion, wherein the cab portion has at least two forward wheels, and wherein the cargo portion exterior defines a bottom surface, a first side with a first side surface, a second side with a second side surface, a front with a front surface and a rear with rear surface, with the and second sides spaced apart at a cargo portion width and with the bottom surface being above ground at a cargo portion height, the aerodynamic device comprising:
(a) a first panel having a first outer surface, a first upper edge, and a first lower edge, the first panel comprising a first forward portion and a first aft portion, wherein:
(i) the first aft portion is attached to the bottom surface of the cargo portion at the first side and extends downwardly from the cargo portion a desired first vertical distance, wherein the first aft portion is substantially coplanar with the first side surface of the cargo portion,
(ii) the first forward portion is attached to the bottom surface of the cargo portion forward of the aft portion and extends downwardly from the cargo portion, wherein the first forward portion extends inwardly from the cargo portion first side for a distance greater than 10% of the cargo portion width;
(b) a second panel having a second outer surface, a second upper edge, and a second lower edge, the second panel comprising a second forward portion and a second aft portion; wherein:
(i) the second aft portion is attached to the bottom surface of the cargo portion at the second side and extends downwardly from the cargo portion a desired second vertical distance, wherein the second aft portion is substantially coplanar with the second side surface of the cargo portion,
(ii) the second forward portion is attached to the bottom surface of the cargo portion forward of the aft portion and extends downwardly from the cargo portion, wherein the second forward portion extends inwardly froth the cargo portion second side for a distance greater than 10% of the cargo portion width;
(c) the first and second lower edges are aerodynamically sharp;
(d) the first forward portion forms a first air dam and the second forward portion forms a second air dam; and
(e) wherein, the first and second air dams are configured such that when the ground vehicle is in forward motion generating a relative flow of air from front to back, substantially all of the air flowing incident under the cargo portion front strikes the first and second air dams and is substantially redirected outboard along the first and second outer surfaces.

2. The aerodynamic device of claim 1, wherein the first and second panels are substantially rigid.

3. The aerodynamic device of claim 1, wherein the first and second panels are substantially flexible.

4. The aerodynamic device of claim 1, wherein the aft portions of the first and second panels comprise a plurality of longitudinal segments.

5. The aerodynamic device of claim 1, wherein first and second vertical distances are less than about 90% of the cargo portion height.

6. The aerodynamic device of claim 1, wherein the first vertical distance and the second vertical distance are substantially equal.

7. The aerodynamic device of claim 1, wherein the aft portions of the first and second panels extend about 10 percent to about 100 percent along the length of the first and second sides.

8. The aerodynamic device of claim 1, wherein forward and aft portions of each panel are connected and integrated into a single integral structure.

9. The aerodynamic device of claim 1, wherein the aft portions of the first and second panels are formed by an integral extension of the first and second sides.

10. The aerodynamic device of claim 1, wherein each panel is configured to define an opening in the aft portion to provide access to wheels of the ground vehicle.

11. The aerodynamic device of claim 1, wherein at least a portion of the first and second panels is removably attached to the bottom surface.

12. The aerodynamic device of claim 1, wherein the forward portions of the first and second panels extend inwardly at an angle with respect to a transverse axis so as to present a substantially swept leading surface.

13. The aerodynamic device of claim 1, wherein the aft portions of the first and second panels have a swept trailing edge.

14. The aerodynamic device of claim 1, wherein the first and second panels extend linearly downward.

15. The aerodynamic device of claim 1, wherein the aft portions of the first and second panels extends curvilinearly downward.

16. The aerodynamic device of claim 1, wherein the lower edges of the first and second panels are flexible.

17. The aerodynamic device of claim 1, wherein the first and second panels are foldably attached to the bottom surface of the cargo portion such that the panels may be folded so as to be substantially proximate the bottom surface.

18. The aerodynamic device of claim 1, wherein at least a portion of the first and second panels are slidably attached to the bottom surface, such that the slidable portion of the first and second panels may slide longitudinally along the vehicle.

19. The aerodynamic device of claim 1, wherein the longitudinal position of the each panel is adjustable.
